(19) United States
(12) Patent Application Publication
(10) Pub. No.: US 2005/0058803 A1
(43) Pub. Date: Mar. 17, 2005

(54) Door casing drop cloth

(76) Inventor: James William Bowden, Brentwood, CA (US)

Correspondence Address: CHARLES LOUIS THOEMING, 1390 WILLOW PASS ROAD, SUITE 1020, CONCORD, CA, 94520, US

(21) Appl. No.: 10/935,807

(22) Filed: Sep. 8, 2004

Related U.S. Application Data
(60) Provisional application No. 60/502,722, filed on Sep. 15, 2003.

(51) Int. Cl. B32B 3/02

(52) U.S. Cl. 428/80

(57) ABSTRACT

A door casing and door drop cloth assembly and method are disclosed. The assembly includes two generally rectangular drop cloths of a durable, flexible material. One of the rectangular drop cloths has cut-out portions centered on the rectangle short sides to receive casings while the cut drop cloth is positioned over the floor surface located beneath, between, and around the casings. The other rectangular drop cloth is positioned on the floor surface, centered lengthwise under the door hung in the casing.

### CROSS-REFERENCES TO RELATED APPLICATIONS

This United States non-provisional patent application is based upon and claims the filing date of U.S. Provisional Patent Application Ser. No. 60/502,722, filed Sep. 15, 2003.

### STATEMENT REGARDING FEDERALLY SPONSORED RESEARCH OR DEVELOPMENT

None.

### REFERENCE TO A MICRO-FICHE APPENDIX

None.

### BACKGROUND OF THE INVENTION

1. Field of the Invention

The present invention relates generally to the field of protective masking devices, and in particular to a durable canvas cloth construction that is designed to cover and protect surface areas between door casings. An embodiment of the present invention is specifically designed to cover floor areas between door casings and under the particular door hung in the respective casing for painting projects in residential or commercial settings.

2. Description of the Related Art

A search of the prior art located the following United States patents which are believed to be representative of the present state of the prior art: U.S. Pat. No. 6,177,164 B1, issued Jan. 23, 2001, U.S. Pat. No. 6,143,392, issued Nov. 7, 2000, U.S. Pat. No. 5,918,312, issued Jun. 6, 1999, U.S. Pat. No. 5,769,368, issued Jun. 23, 1998, and U.S. Pat. No. 4,934,833, issued Jun. 19, 1990.

U.S. Pat. No. 6,177,164 B1, issued Jan. 23, 2001, discloses a high chair drop cloth system.

U.S. Pat. No. 6,143,392, issued Nov. 7, 2000, discloses a drop cloth construction for railings and bannisters.

U.S. Pat. No. 5,918,312, issued Jun. 6, 1999, discloses a garment with detachable drop cloth.

U.S. Pat. No. 5,769,368, issued Jun. 23, 1998, discloses a drop cloth holder and dispenser.

U.S. Pat. No. 4,934,833, issued Jun. 19, 1990, discloses a combination ladder bag and drop cloth.

### BRIEF SUMMARY OF THE INVENTION

Typical masking methods in the art use a combination of tape and protective materials such as paper, plastic sheeting, and/or canvas. Painters and other tradespeople arrange the protective material so that floors or other designated surfaces are protected from paint. These masking materials are then secured by taping them to adjoining surfaces or to the surface being protected. For special areas presenting uniform but multi-dimensional geometries, such as door casings, fitting masking material and securing them with tape is imprecise, time consuming, and costly. Once the casing and door have been painted, used but un-removed masking materials around door casings often become point sources for contamination of unprotected areas.

The present invention relates to a durable canvas cloth construction that is designed to protect the floor areas between a door jamb. An embodiment of the present invention is specifically designed to cover floor areas between door casings and under the particular door hung in the respective casing for residential and commercial painting projects.

The present invention is constructed from ten ounce cotton duck canvas, or similar durable, flexible material. An embodiment of the present invention includes a kit providing pre-sized drop cloths for standard residential or commercial door casings. As such, a quicker, more efficient means of masking off a door and its casing is provided. The drop cloth of the present invention can be positioned within seconds, and is transported to the next door casing just as quickly. The drop cloth of the present invention is washable and re-usable, thus saving the user on time and materials. Because it can be quickly removed and replaced, there is little likelihood of persons working in the area tracking paint from the drop cloth to clean floor surfaces.

It is therefore an object of the present invention to provide a new and improved drop cloth assembly which has all of the advantages of prior art drop cloths and none of the disadvantages.

It is another object of the present invention to provide a new and improved drop cloth assembly which may be easily and efficiently manufactured and marketed.

It is a further object of the present invention to provide new and improved drop cloth assembly which is of durable and reliable constructions.

An even further object of the present invention to provide a new and improved drop cloth assembly which is susceptible of low cost of manufacture with regard to both materials and labor, and which accordingly in then susceptible of low prices of sale to the consuming public, thereby making such drop cloth assembly economically available to the buying public.

It is still further an object of the present invention to provide a drop cloth assembly for rendering more convenient clean-up by a user after painting the surface areas above the drop cloth assembly.

Lastly, it is an object of the present invention to provide a new and improved drop cloth assembly and system including a pre-sized, member to fit standard door casings in residential and commercial settings, having sufficient surface area to protect floors surfaces below the casings while the casings are painted or otherwise treated. The assembly and system further includes a drop cloth member adapted to be positioned under a door in a door casing to further protect the floor surface beneath the door while the door is painted or otherwise treated.

These together with other objects of the invention along with the various features of novelty which characterize the invention are pointed out with particularity in the claims annexed to and forming a part of this disclosure. For a more complete understanding of the invention, its operating advantages and the specific objects attained by its uses, reference should be had to the accompanying drawings and descriptive matter in which there is illustrated preferred embodiments of the invention. All other features, advantages, and objects of the present invention will become apparent with reference to the following description and accompanying drawings.

### BRIEF DESCRIPTION OF DRAWINGS

FIG. 1 is a perspective view of an embodiment of the present invention for door casing and door drop cloth in position in a door casing and under a hung door in the casing for applying paint to the casing and door.

FIG. 2 is a detail perspective view of an embodiment of the present invention for door casing drop cloth depicting the cloth fitted over the prepared and taped floor around a door casing.

FIG. 3 is a top view of an embodiment of the present invention for door casing drop cloth.

FIG. 4 is a top view of an embodiment of the present invention for door drop cloth.

FIG. 5 is a sectional view of FIG. 3 showing the rolled and sewn edges of the drop cloth assembly.

### DETAILED DESCRIPTION OF THE INVENTION

The present invention provides a drop cloth assembly adapted to be used to protect horizontal surfaces between and surrounding door casings and an open door hung therein during painting or similar preparation or finish work on the casing and door. The present invention includes a first flexible material having two parallel long sides of equal length, two parallel short sides of equal length perpendicular to the long sides, a top, a bottom, border edges, a longitudinal centerline, and two symmetrically sized cut-out portions centered on each short side length at the longitudinal centerline providing generally an “H” configuration. The cut-out portions of the “H” configuration are sized to receive a door casing. The longitudinal centerline distance between the cut-out portions corresponds to the width of the door casing opening. The “H” shaped, first material is sized to mask an area of floor surface within and extending beyond the door casing, and can be prefabricated to standard code door casing widths of twenty-eight inches for residential door casings or thirty-two inches for commercial door casings. A second flexible material having a rectangular geometry, a top, a bottom, and border edges is provided for the door. The rectangular material is sized to protect the flooring surfaces beneath the door hung in the casing during painting or similar preparation or finish work on the door.

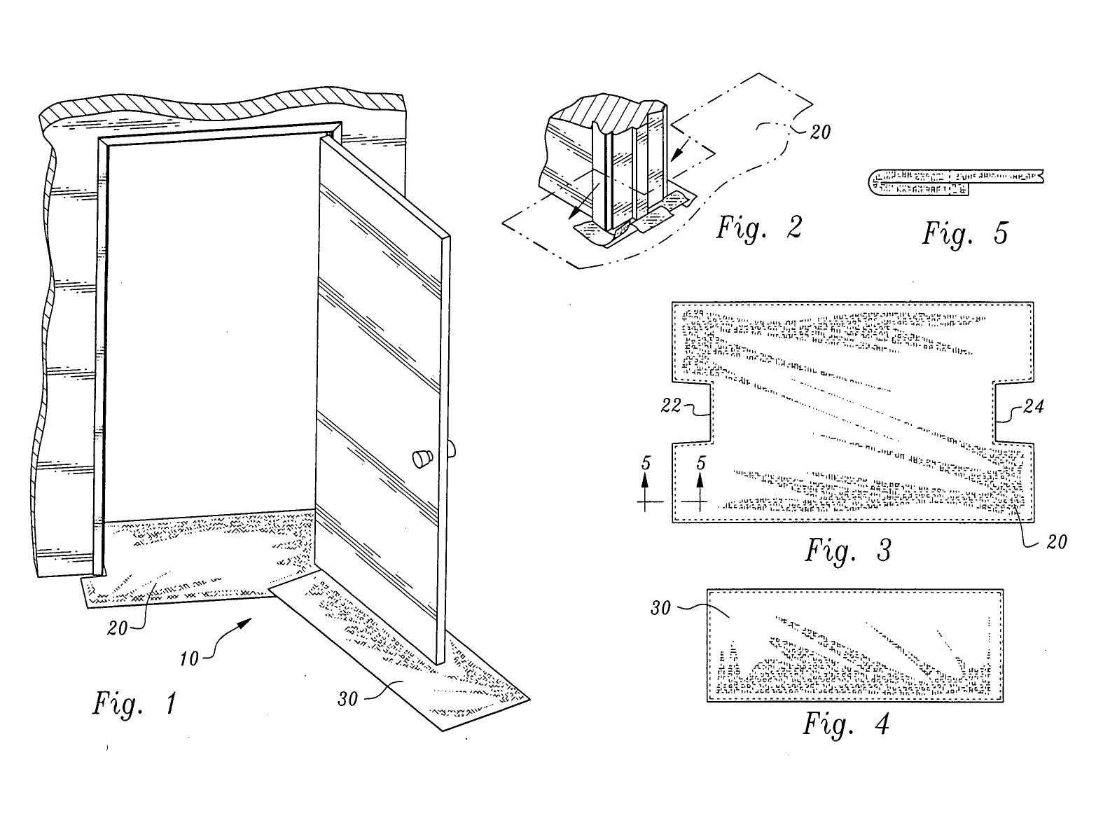

With reference to the drawing FIGS. 1-5, an embodiment of the present invention for an improved drop cloth for door casings and doors 10 is generally depicted.

FIG. 3 depicts an embodiment of the present invention in which a flexible piece of substantially fluid impervious material is sized and cut to be used on standard door casings of varying sizes according to commercial or residential code requirements. The door casing drop cloth 20 depicted in FIG. 3 is generally a suitably sized rectangular piece of material with two symmetrically sized cut-out portions 22 and 24 centered on each short length of the rectangle. The cut-out portions 22 and 24 are sized according to standard door casing member widths and/or door jamb dimensions according to commercial or residential code requirements providing a fitted masking piece. A second un-cut rectangular drop cloth 30 comprising a flexible piece of substantially fluid impervious material is provided by the door casing drop cloth assembly of the present invention to be placed under the door being painted or otherwise treated, FIGS. 1 and 4. Both the fitted cut and solid rectangular pieces are sized to adequately protect the surface area sought to be protected within the applicable door casing dimensions and under a hung door as determined by code requirements.

The drop-cloths of the present invention could be constructed from a canvas-like material. The drop cloth material could be treated or sprayed with materials, such as polyurethane, to prevent paint or other liquids from soaking through the drop cloth. The drop cloth material could also be color treated for purposes of easily identifying the specific sizing of the drop cloth or to correspond to the paint application. The preferred embodiment of the present invention uses 10 ounce cotton duck canvas as drop cloth material for both the fitted and rectangular pieces. As depicted in FIGS. 3, and 5, the 10 ounce cotton duck canvas of the embodiments of drop cloth is double rolled at the drop cloth edges and the rolled edges are individually sewn to prevent fraying. The same stitched, rolled edge treatment is provided for the rectangular piece.

Use of the present invention for protection of floor surfaces during painting of a door casing is achieved in a few simple and quick steps. First the painter prepares the casing area by applying masking tape or similar materials to the flooring surfaces around the door casing to be painted. The drop cloths are then positioned in the casing opening and under the door. As depicted in FIGS. 1 and 2, the fitted, cut drop cloth 20 is positioned on the floor in the door casing opening with the respective cut-out portions 22 and 24 each receiving and fitting over the flooring surface around a corresponding door casing. The cut drop cloth 20 covers the tape and floor surface within the door jamb and casings, FIG. 2. The un-cut, rectangular drop cloth 30 is positioned on the floor under the hung door by centering the rectangular drop cloth 30 lengthwise under the hung door. A portion of the rectangular drop cloth 30 overlaps the cut drop cloth 20 at the hinged end of the door. A portion of the rectangular drop cloth 30 extends beyond the open end of the door. Once the door and casing have been painted, the drop cloths 20 and 30 are removed and positioned into the next taped and prepared casing to be painted and under the door hung therein. These steps are quickly and easily repeated for the number of doors and door casings to be painted in the particular painting project.

Although the present invention can be sized for any door casing, the drop cloth assembly of the present invention can be provided in pre-packaged kits wherein the dimensions of the drop cloths 20 and 30 are sized to standard code requirement for residential and commercial door casings. One embodiment of pre-packaged kit provides: 1) a sewn drop cloth 20 which measures twenty-three inches by thirty-five and one half inches, wherein each sewn cut-out section 22 and 24 is four inches by nine inches, and the longitudinal centerline distance between the cut-out portions is twenty-seven and one half inches; and 2) a second sewn drop cloth 30 which measures twenty-three inches by thirty-three and three quarters inches.

Another embodiment of pre-packaged kit provides: 1) a sewn drop cloth 20 which measures twenty-three inches by thirty-five and one half inches, wherein each sewn cut-out section 22 and 24 is six inches by nine inches, and the longitudinal centerline distance between the cut-out portions is twenty-three and one half inches; and 2) a second sewn drop cloth 30 which measures twenty-three inches by thirty-three and three quarters inches.

Accordingly, a quicker, more efficient, and more cost effective means of masking the floor beneath, between and around door casings and beneath a door hung therein for painting or similar treatment has been disclosed.

With respect to the above description then, it is to be understood and realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

A latitude of modification, change and substitution is intended in the foregoing disclosure, and in some instances some features of the invention will be employed without a corresponding use of other features. Therefore, it is appropriate that the appended claims be considered broadly and in a manner consistent with the spirit and scope of the invention disclosed herein.

1. A kit for drop cloth assembly adapted to be used to protect horizontal surfaces between and surrounding door casings and an open door hung therein, the kit comprising in combination:
a first flexible material having two parallel long sides of equal length, two parallel short sides of equal length perpendicular to the long sides, a top, a bottom, border edges, a longitudinal centerline, and two symmetrically sized cut-out portions, with one cut-out portion centered on each short side at the longitudinal centerline; and
a second rectangular flexible material having a top, a bottom, and border edges.

2. The kit of claim 1, wherein the cut-out portions are sized to receive a door casing, the longitudinal centerline distance between the cut-out portions corresponds to the width of the door casing opening, and the first material is sized to mask an area of flooring within and beyond the door casing.

3. The kit of claim 2, wherein the longitudinal centerline distance between the cut-out portions is twenty-seven and one half inches.

4. The kit of claim 2, wherein the longitudinal centerline distance between the cut-out portions is twenty-three and one half inches.

5. The kit of claim 1, wherein the second rectangular material is sized to mask an area of flooring beneath an open door hung within a door casing.

6. The kit of claim 1, wherein all material is substantially fluid impervious.

7. The kit of claim 1, wherein all material is ten ounce cotton duck canvas.

8. The kit of claim 1, wherein all border edges are rolled and sewn.

9. The kit of claim 1, wherein all material is treated with color-fast dye.

10. The kit of claim 1, wherein all material is treated with polyurethane.

11. A door casing and door drop cloth assembly comprising
a first member comprising two long parallel sides of equal length, two short parallel sides of equal length perpendicular to the long sides, a top, a bottom, border edges, a longitudinal centerline, and two symmetrically sized cut-out portions, with one cut-out portion centered on each short side at the longitudinal centerline providing an overall “H” shape for the first member;
a second member having a rectangular geometry, a top, a bottom, and border edges;
wherein the first and second member comprise material selected from the group consisting of canvas, canvas treated with polyurethane, and color-fast dyed canvas;
wherein all border edges are double rolled from top to bottom and sewn;
wherein the cut-out portions are sized to receive a door casing, the longitudinal centerline distance between the cut-out portions corresponds to the width of the door casing opening, and the first member is sized to mask an area of flooring within and beyond the door casing; and
wherein the second member is sized to mask an area of flooring beneath an open door hung within the door casing.

12. The drop cloth assembly of claim 11, wherein the sewn first member is twenty-three inches by thirty-five and one half inches, each sewn cut-out section is four inches by nine inches, the longitudinal centerline distance between the cut-out portions is twenty-seven and one half inches, and the sewn second member is twenty-three inches by thirty-three and three quarters inches.

13. The drop cloth assembly of claim 12, wherein each sewn cut-out section is six inches by nine inches and the longitudinal centerline distance between the cut-out portions is twenty-three and one half inches.

14. A method of using the drop cloth assembly of claim 1 on a painting project for door casings and doors hung therein, the method comprising the steps:
providing at least one door casing defining a single door jamb with door hung therein to be painted, the door providing a hinged end and an open end;
providing at least one door casing drop cloth kit according to claim 1;
applying masking tape to the flooring surfaces surrounding each door casing;
positioning a drop cloth having cut-out portions on the floor surface between the casings in a door jamb such that each cut-out portion receives and surrounds a door taped casing and the drop cloth covers the tape and floor surface beneath and within the casing;
positioning a rectangular drop cloth by centering it longitudinally lengthwise under the hung door wherein a portion of the rectangular drop cloth overlaps the drop cloth having cut-out portions at the door hinged end and a portion of the rectangular drop cloth extends beyond the door open end;
painting the door casing and the door;
removing the drop cloths; and
repeating these steps for as many door casings and doors as necessary to complete the painting project.
